(19) United States
(12) Patent Application Publication
(10) Pub. No.: US 2014/0314058 A1
(43) Pub. Date: Oct. 23, 2014

(54) Optimizing device service availability and usage in a wireless personal network

(71) Applicants: Robbin Hughes, Plano, TX (US); Thomas O'Neill, La Jolla, CA (US); Prem Jothipragasam Kumar, San Diego, CA (US); Ramesh Rajasekaran, Chennai (IN)

(72) Inventors: Robbin Hughes, Plano, TX (US); Thomas O'Neill, La Jolla, CA (US); Prem Jothipragasam Kumar, San Diego, CA (US); Ramesh Rajasekaran, Chennai (IN)

(21) Appl. No.: 13/868,581

(22) Filed: Apr. 23, 2013

(51) Int. Cl. H04W 84/12

(52) U.S. Cl. CPC H04W 84/12
USPC 370/338

(57) ABSTRACT

The proposed embodiment provides a method and system for automatically optimizing services in a network. The method includes receiving parameters associated with services of one or more devices in the network, prioritizing the parameters associated with the services in accordance to a plurality of rules, and selecting an optimized service associated with the devices based on the assigned priorities of the parameters associated with the services.

### TECHNICAL FIELD

The present embodiment relates to a wireless communications network and, more particularly, to a system and method for optimizing device service availability and usage in the wireless communications network.

### BACKGROUND

With the advent of cellular and wireless technologies, many users commonly utilize personal area networks (PANs) including various devices offering different types of services to the user. The devices may be arranged in an ad-hoc fashion to dynamically communicate among each other, based on the device characteristics and service capabilities. Such dynamic network(s) may include a limited set of services preferred by the user. The set of services can be null or may include a plurality of devices offering substantially similar (or same) set of services in different ways regardless of service quality and usage by the user. Providing optimal device services based on the user requirements involve significant challenges.

Different methods and systems are proposed to provide optimal services to the user. The conventional system and method allows the user to manually select the device to use the desired service. A list of devices offering desired service(s) is presented to the user for manually accessing the list to choose the optimal device which may offer the desired service. Further, mobility of the devices may include rapid changes in the network connectivity, availability, link quality, service capability, and bandwidth management. As the devices frequently enter and leave the network, the determination of the optimal device offering the desired services may need to be frequently evaluated and re-evaluated, which may require significant amount of system time and cost thereby decreasing the overall throughput and performance of the system. Thus, the conventional system and method may require a subjective understanding of each device in the network in terms of the device and service availability, characteristics, offered services, services quality, user preferences, range, speed, bandwidth, workload, congestion, time, cost, and the like.

### BRIEF DESCRIPTION OF THE FIGURES

The embodiments herein will be better understood from the following detailed description with reference to the drawings, in which:

FIG. 1 illustrates generally, among other things, a system in which the present embodiment is embodied, according to embodiments described herein;

FIG. 2 expands features and functions of the system as described in the FIG. 1, according to embodiments described herein;

FIG. 3 is a sequence diagram illustrating generally operations performed by controller as described in the FIGS. 1 and 2, according to embodiments disclosed herein; and

FIG. 4 illustrates a flow chart illustrating a method for optimizing device services in a network, according to embodiments disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein disclose a system and method for optimizing device services in a wireless personal network. A controller (or hub) is configured to include information about the services offered by each device in the network. A decision metric can be computed based on one or more parameters associated with each service of the devices throughout the network, such as to select optimal device service for user(s). Further, the controller can receive the one or more parameters associated with each wireless device in the vicinity of the network. Each parameter received by the controller can be prioritized for detecting the optimal device service within the network. The priority or appropriateness of each parameter associated with the service can be determined based on one or more rules indicating the requirement or preferences of the user. Whenever a service request is initiated, the controller can assign a priority to each parameter of a service based on the plurality of rules. Further, the controller combines the priorities of all the parameters associated with each service and selects an optimal device service for the user upon determining that a sum of all priorities of the parameter associated with a service reaches a predefined priority threshold.

The proposed system and method is simple, reliable, and robust for selecting optimal service in the network based on the user requirement and usage. The automatic nature of the present embodiment may improve the user experience and increase the system performance with significantly decreased time and cost. The system and method can be used to enhance the service availability and usage in the network by selecting optimal service based on plurality of rules including the user preferences and requirements. Such a rule-based system can be used to increase the system response time and provide effective services to the user. Further, the system and method can be used to provide seamless and uninterrupted services to the user by automatically switching among devices. A complete optimal solution can be offered to the user by providing such seamless and personalized services to the user. Furthermore, the proposed system and method can be implemented on the existing infrastructure and may not require extensive set-up or instrumentation.

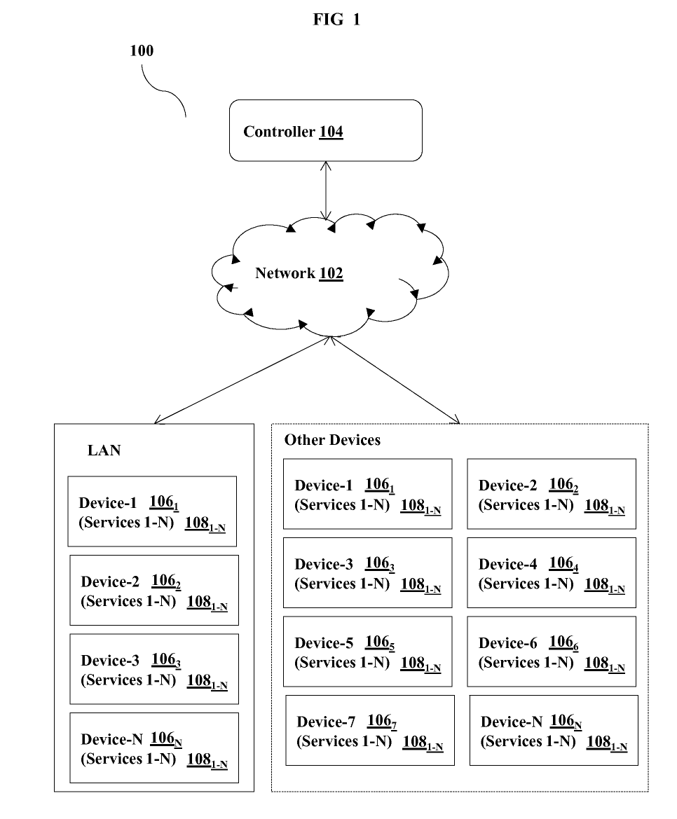

Referring now to the drawings, and more particularly to FIGS. 1 through 4, where similar reference characters denote corresponding features consistently throughout the figures, there are shown embodiments.

FIG. 1 illustrates generally, among other things, a system 100 in which the present embodiment is embodied, according to embodiments described herein. The system 100 can include a network 102, a controller 104, and one or more devices 106_{1-N} (hereafter referred as device(s) 106). The network 102 described herein can be for example, but not limited to, wireless network, wire line network, public network such as the Internet, private network, global system for mobile communication network (GSM) network, general packet radio network (GPRS), local area network (LAN), wide area network (WAN), metropolitan area network (MAN), cellular network, public switched telephone network (PSTN), personal area network, a combination thereof, or any other network.

In an embodiment, the controller 104 described herein can include for example, but not limited to, gateway device, router, hub, computer, laptop, wireless electronic device, personal digital assistance, smart phone, and the like. The controller 104 can be configured to include interfaces to connect with the devices 106 throughout the network 102. The controller 104 can be capable of coordinating the service requests and processing data to provide the requested (desired) services.

In an embodiment, the device(s) 104 described herein can include for example, but not limited to, gateway device, router, hub, computer, laptop, wireless electronic device, personal digital assistance, smart phone, and the like. The devices 106 can be configured to provide one or more services 108_{1-N} (hereafter referred as service(s) 108) to provide various functionalities and features to user(s). The devices 106 can be configured to include appropriate interfaces such to directly or indirectly communicate with the controller 104 and among each other over the network 102. Further, the devices 106 can be configured to include different, same, or substantially similar services for the users. In an embodiment, the services 108 described herein can include for example, but not limited to, web services, financial services, transaction services, social services, multimedia services, business services, economic services, technical services, religious services, data transfer services, printing services, ecommerce services, or any other type of services. Each service 108 can provide different advantages in terms of device availability, service availability, device characteristics, service characteristics, service quality, communication links/channel, user preferences, security, power consumption, usage, range, speed, bandwidth, workload, congestion, and the like.

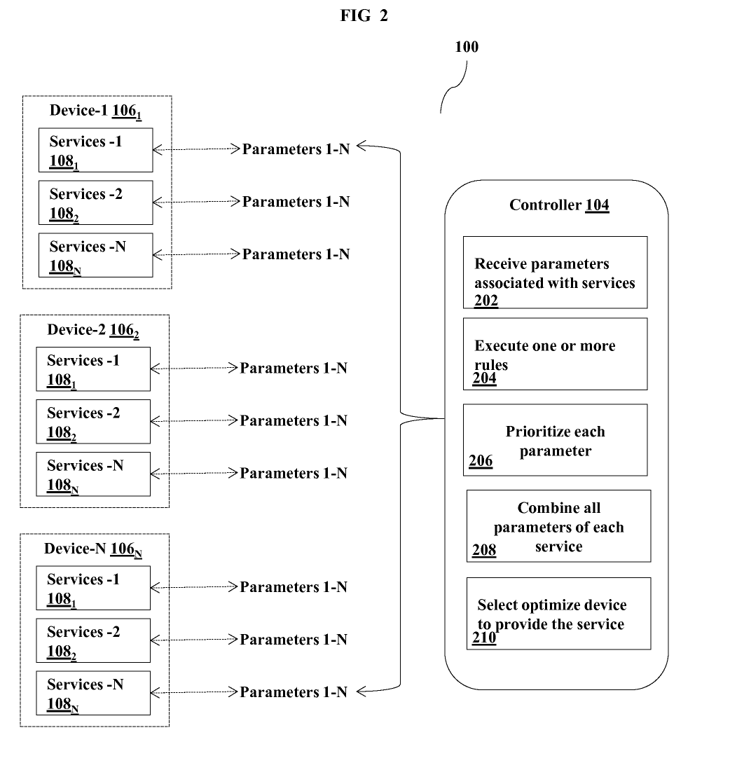

Further, the controller 104 can be configured to continuously monitor a plurality of parameters associated with each service offered by the devices 106 in the network 102. In an embodiment, the parameters described herein can include for example, but not limited to, device availability, device characteristics, services offered, communication link/channel, profile, service availability, service characteristics, service quality, user preferences, usage, range, speed, bandwidth, workload, congestion, and any other parameter. Further, whenever a service is requested by the user, the controller 104 can be configured to prioritize the parameters of each service associated with the device 106. The detailed description of the system 100 is described in conjunction with FIGS. 2-4.

In an embodiment, hardware portions corresponding to the system 100 may be included to provide the transmission and reception of signals among the devices 106, such as to provide the effective services 108 to the user. Accordingly, the portions may include components (e.g., electronics) that perform functions, such as modulation, demodulation, amplification, and filtering. The various components in the network 102 may include for example, but are not limited to, servers, printers, speakers, mobile phones, any computational devices including among other things: a camcorder, a personal computer; a telephone, a personal communications system (PCS), facsimile, data communicators, personal music players (PMPs); personal digital assistants (PDAs), global positioning systems (GPSs), and any other components.

FIG. 2 expands features and functions of the system 100 as described in the FIG. 1, according to embodiments described herein. As in the FIG. 2, the devices 106 can offer a plurality of services in the network 102. The controller 104 can be configured to continuously monitor and receive the parameters (1-N) associated with each services 108 of the devices 106 throughout the network 102 as shown at 202.

In an embodiment, each service of the device 106 can be associated with a number of corresponding parameters that can be tuned to affect the performance and responsiveness of the system 100. In an example, the parameters described herein can include for example, but not limited to, device availability, device characteristics, services offered, communication link/channel, profile, the service availability, the service characteristics, the service quality, user preferences, near-by devices, security, power consumption, usage, range, speed, bandwidth, workload, congestion, and the like.

Further, in an example, the device characteristic parameter described herein can include for example, but not limited to, battery level, communication link/channel information (further including the channel quality derived from derived Signal-to-Noise Ratio (SNR)), different types of communications link used by the devices (for example, Bluetooth, ZigBee, Wi-Fi, P2P, ultra wideband, and the like), routing information, cost, device mobility, and the like. In an example, the service characteristic parameter described herein can include for example, but not limited to, quality of service, service mobility, the cost associated with service, user service usage history, and the like. In an example, the profile parameter described herein can include for example, but not limited to, mode in which the device is running such as power saving mode, idle mode, sleep mode, and the like.

Any changes in these parameters can affect the performance, sensitivity, cost, and reliability of the system 100. Further, the controller 104 can be configured to receive service(s) request from the user. In response to receiving the request the controller 104 can be configured to prioritize each received parameter associated with each service of the device 106, based on the stored one or more rules. In an embodiment, the controller 104 can be configure to execute the one or more rules on each parameter associated with the services, such as to prioritize the parameters based on the user needs and preferences as shown at 204.

In an embodiment, the one or more rules described herein can include elements indicating the user preferences and needs. In an example, the elements described herein can include for example, but not limited to, user historic activities, user interest, user frequent services, user service usage, user service cost plans, user device battery level, communication link/channel, profile, service quality requirement data, range, speed, bandwidth, workload, congestion, or any other elements.

In an embodiment, the controller 104 can be configured to prioritize the parameters by assigning a value (on scale of 1 to 10) to each parameter based on the one or more applicable rules as shown at 206. For example, if a user sends a request to access multimedia service (such as to play an audio file) over the network 102. The devices such as a home theatre, a speaker, and the like may be present in the network 102 to provide the multimedia services. The controller 104 can be configured to prioritize the parameters associated with the multimedia services of all such devices based on the one or more rules indicating the user requirements. An exemplary pseudo code of predefined rules for prioritization of exemplary parameters such as battery level, communication channel, range, and link quality (on scale of 1 to 10) are as follows:

Priority Rule-1 (Parameter=Battery Level and User History):
If battery level is greater than 50% and user history suggests device preferred during previous sessions is home theatre then
Assign priority value as 8 else assign priority value as 4

Priority Rule-2 (Parameters=Link Quality, communication Channel, and Range):
If device link quality has SNR>12 dB
Assign priority value as 8 else assign priority value as 4
If communication link is Wi-Fi and user preference is Wi-Fi
Assign priority value as 8
If device location is within 5 m of range and user preference indicates good sound quality
Assign priority value as 9 else assign as 2

Further, the controller 104 can be configured to combine the priorities of all the parameters associated with the multimedia service of the device as shown at 208. The controller 104 can calculate a sum of all the priorities of the parameters associated with each service of the device. For example, if the priority value assigned to the battery level parameter and link quality parameter are 8 and 9 respectively, then controller 104 can calculate the sum as of all the priorities as, for example, 8+9=17. Furthermore, the controller 104 can be configured to select the optimal device service by comparing the sum to a predefined threshold as shown at 210. The predefined threshold can be a decision matrix (such as value or threshold limits) for determining the optimal device for providing the desired service to the user. In an embodiment, the priority threshold can be predefined by network administrator or evaluated by the controller 104 based on the one or more rules. If the combined sum of priorities of all the parameters associated with a service reaches the threshold then the controller 104 can be configured to choose that device as optimal device for offering the desired service and automatically switch to the selected device to provide the optimal service.

In an embodiment, the controller 104 can select the optimal device for the user to provide the service upon determining that the combined priority (or the calculated sum of all the priorities) of the parameters reaches the predefined priority threshold. For example, if the threshold is defined to a value 6 and the controller 104 determines the sum of priorities of all the parameters associated with the multimedia service of the home theatre device is 17 and the speaker is 13 then the controller 104 selects the home theatre as the most optimal device to provide the desired multimedia service to the user while rejecting the speaker device.

Further, the controller 104 ensures that the parameters associated with services are prioritized in order of appropriateness and requirements of the user based on the one or more rules. The controller 104 can be configured to include various combinations of elements, such as to provide priorities to each parameter of a service. Further, various other elements such as user preferences, user history, network administrator preferences, device profile, controller profile, device battery level, controller battery level, device status (active/sleep/idle), controller status (active/sleep/idle), communication channels, and the like, can be considered while providing priorities to the parameters. Furthermore, the exemplary priorities and pseudo code described herein are only for illustrative purpose and does not limit the scope of the embodiment. In real-time the priorities may be given using weighing factor, rank ordering methods, stars, ratings, and the like. Furthermore, the rules and prioritization can be implemented/performed in any order/form and other elements, components, steps, and operations, may be added, skipped, deleted, and modified without departing from the scope of the embodiment.

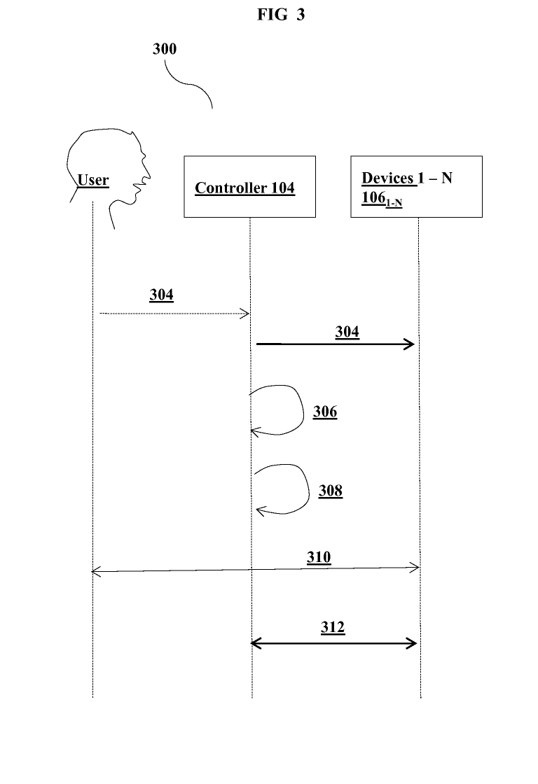

FIG. 3 is a sequence diagram 300 illustrating generally operations performed by the controller 104 as described in the FIG. 2, according to embodiments disclosed herein. In an embodiment, at 302, the controller 104 can receive one or more request from a user to access the services offered by the device 106. In an embodiment, at 304, the controller 104 can receive a plurality of parameters associated with the service 108 of the device 106 over the network 102. In an example, the parameters described herein can include for example, but not limited to, device availability, device characteristics, services offered, communication link/channel, profile, the service availability, the service characteristics, the service quality, user preferences, usage, range, speed, bandwidth, workload, congestion, and any other parameter. Any changes in these parameters can affect the performance, sensitivity, cost, and reliability of the system 100.

In an embodiment, at 306, the controller 104 can prioritize the parameters associated with the service 108 of the device 106 based on the one or more rules. In an example, the controller 104 can prioritize the parameters by assigning a value (on scale of 1 to 10) to each parameter based on the one or more applicable rules. The rules described herein can include elements such as for example, but not limited to, user historic activities, user interest, user frequent services, user service usage, user service cost plans, user device battery level, communication link/channel, profile, service quality requirement data, range, speed, bandwidth, workload, congestion, or any other elements indicating the user preferences and needs.

In an embodiment, at 308, the controller 104 can combine the assigned priorities (values) of all the parameters associated with each service 108 of the device 106. In an example, the controller 104 can calculate a sum of all the priorities (values) assigned to the parameters associated with each service of the device. In an embodiment, at 310, the controller 104 can select the optimal device service by comparing the sum of all the priorities of parameters associated with each service to a predefined threshold. The predefined threshold described herein can include a decision matrix (such as a value or threshold limits) to determine the optimal device for the providing the desired service to the user. The priority threshold can be predefined by a network administrator (or by any other user) or evaluated by the controller 104 based on the one or more rules. The controller 104 can select the optimal device for the user to provide the service upon determining that the combined priority (or the calculated sum of all the priorities) of the parameters reaches the predefined priority threshold.

In an embodiment, at 312, the controller 104 can frequently monitor the parameters associated with the service 108 of the device 106 to automatically manage and switch among the devices offering the desired service. The frequent monitoring of the service parameters can allow the controller 104 to provide seamless, optimal, personalized, reliable, uninterrupted, and enhanced services to the user.

The various operations, acts, or steps described with respect to the FIG. 3 can be performed in the order present, simultaneously, parallel, combination thereof, or in any order. The operations, acts, or steps herein are only for illustrative purpose and do not limit the scope of the embodiment. Further, in some embodiments some of the operations, acts, or steps can be added, skipped, omitted, or modified without departing from the scope of the embodiment.

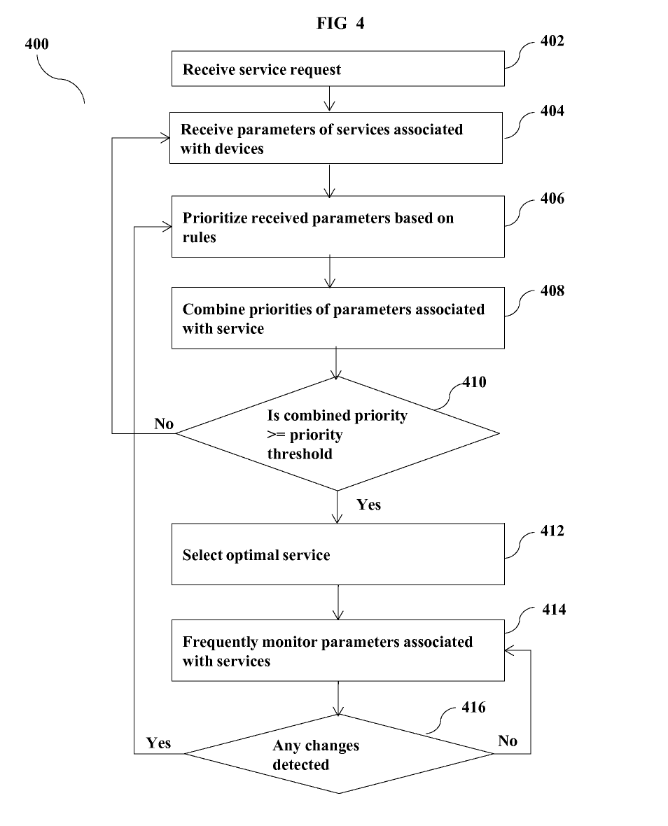

FIG. 4 illustrates a flow chart illustrating a method 400 for optimizing device services in the network 102, according to embodiments disclosed herein. In an embodiment, at 402, the method 400 includes receiving a request from the user to access a service 108. In an example, the method 400 allows the controller 104 to receive request representing desired service required by the user. In an embodiment, at 404, the method 400 includes receiving a plurality of parameters associated with the services 108 of the devices 106. In an example, the method 400 allows the controller 104 to send request to the devices 106 to receive the parameters associated with the service 108 throughout the network 102. The parameters described herein can include for example, but not limited to, device availability, device characteristics, services offered, communication link/channel, profile, the service availability, the service characteristics, the service quality, communication links/channel, user preferences, usage, range, speed, bandwidth, workload, congestion, and any other parameter.

In an embodiment, at 406, the method 400 includes prioritizing the received parameters based on the one or more stored rules. In an example, the method 400 allows the controller 104 to prioritize the received parameters of the service 108 by applying the rules including elements related to the user requirements. A value (on scale of 1 to 10) can be assigned to each parameter based on the one or more applicable rules. In an example, the rules can include elements such as for example, but not limited to, user historic activities, user interest, user frequent services, user service usage, user service cost plans, user device battery level, communication link/channel, profile, service quality requirement data, range, speed, bandwidth, workload, congestion, or any other elements indicating the user requirements and needs.

In an embodiment, at 408, the method 400 includes combining the priorities of all the parameters associated with the service 108. In an example, the method 400 allows the controller 104 to combine all the priorities (the values assigned to each parameter) of the service 108. A sum of all the priorities assigned to the parameters associated with the service 108 is calculated by the controller 104.

In an embodiment, at 410, the method 400 includes determining whether the sum of all the priorities exceeds a priority threshold. In an example, the method 400 allows the controller 104 can select the optimal device service by comparing the sum of all the priorities to the predefined threshold. The predefined threshold described herein can be a decision matrix including a value or threshold limits to determine the optimal device for the providing the desired service to the user. The priority threshold can be pre-defined by the network administrator or evaluated by the controller 104 based on the one or more rules.

In an embodiment, at 412, the method 400 includes selecting optimal service upon determining that the sum of all the priorities of the parameters associated with the service 108 reaches the predefined threshold. In an embodiment, at 414, the method 400 includes continuously monitoring the parameters associated with the services, such as to automatically manage and switch among the devices offering the desired service. The frequent monitoring of the service parameters can allow the controller 104 to provide seamless, optimal, personalized, reliable, uninterrupted, and enhanced services to the user. In an embodiment, at 416, the method 400 includes determining if any changes occurred in the parameters associated with the services while providing the service to the user. Any changes in the parameters can affect the performance, sensitivity, cost, and reliability of the controller 104. In an embodiment, upon detecting any changes in the parameters, the method 400 includes repeating the steps 406 through 416, such as to provide seamless and uninterrupted service to the user.

The various actions, units, steps, blocks, and acts described in the method 400 may be performed in the order presented, in a different order, or simultaneously. Further, in some embodiments, some actions, units, steps, blocks, and acts listed in the FIG. 4 may be omitted, added, skipped, and modified without departing from the scope of the embodiment.

The embodiments disclosed herein can be implemented through at least one software program running on at least one hardware device and performing network management functions to control the network elements. The network elements shown in the FIGS. 1-4 include blocks which can be at least one of a hardware device, or a combination of hardware device and software module.

The embodiment disclosed herein specifies a system for optimizing device service availability and usage in a wireless personal area network. The mechanism allows optimum service selection based on the one or more rules embodied in the system thereof. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the embodiment may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for automatically optimizing services in a network, the method comprising:
receiving at least one parameter associated with at least one service of at least one device in said network;
prioritizing said at least one parameter associated with said at least one service in accordance to a plurality of rules; and
selecting at least one optimized service associated with said at least one device based on said priorities of said at least one parameter associated with said at least one service.

2. The method of claim 1, wherein said method further comprises:
combining said priorities of said at least one parameter associated with said at least one service of said at least one device in said network;
determining whether said combined priorities of said at least one parameter associated with said at least one service of said at least one device reaches a predefined priority threshold; and
selecting said at least one optimized service upon determining that said combined priorities of said at least one parameter associated with said at least one service of said at least one device reaches said predefined priority threshold.

3. The method of claim 1, wherein said at least one parameter comprises at least one of said device availability, said device characteristics, services offered by said device, communication channel, profile data, said service availability, said service characteristics, said service quality, user preferences, usage data, range, speed, bandwidth, workload, power consumption data, security data, and congestion.

4. The method of claim 1, wherein said plurality of rules comprises at least one element associated with at least one of said controller and said device.

5. The method of claim 1, wherein said method further comprises communicating at least one request to receive said at least one parameter associated with said at least one service of said at least one device in said network.

6. The method of claim 1, wherein said method further comprises frequently monitoring said at least one parameters associated with said at least one service of said at least one device in said network.

7. The method of claim 6, wherein said method further comprises switching among said services associated with said at least one device based on at least one said monitoring result and said plurality of rules.

8. A system for automatically optimizing services in a network, the system comprising a controller configured to:
receive at least one parameter associated with at least one service of at least one device in said network,
prioritize said at least one parameter associated with said at least one service in accordance to a plurality of rules, and
select at least one optimized service associated with said at least one device based on said priorities of said at least one parameter associated with said at least one service.

9. The system of claim 8, wherein said controller is further configured to:
combine said priorities of said at least one parameter associated with said at least one service of at least one device in said network,
determine whether said combined priorities of said at least one parameter associated with said at least one service of said at least one device reaches a predefined priority threshold, and
select said at least one optimized service upon determining that said combined priorities of said at least one parameter associated with said at least one service of said at least one device reaches said predefined priority threshold.

10. The system of claim 8, wherein said at least one parameter comprises at least one of said device availability, said device characteristics, services offered by said device, communication channel, profile data, said service availability, said service characteristics, said service quality, user preferences, usage data, range, speed, bandwidth, workload, security data, and congestion.

11. The system of claim 8, wherein said plurality of rules comprises at least one element associated with at least one of said controller and said device.

12. The system of claim 8, wherein said controller is further configured to communicate at least one request to receive said at least one parameter associated with said at least one service of said at least one device in said network.

13. The system of claim 8, wherein said controller is further configured to frequently monitor said at least one parameters associated with said at least one service of said at least one device in said network.

14. The system of claim 13, wherein said processor is further configured to switch among said services associated with at least one device based on at least one said monitoring and said plurality of rules.
